(19) United States
(12) Patent Application Publication
(10) Pub. No.: US 2007/0032893 A1
(43) Pub. Date: Feb. 8, 2007

(54) Wearable electronic scorekeeping device

(76) Inventor: Katie Lowran, Traverse City, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/492,249

(22) Filed: Jul. 25, 2006

Related U.S. Application Data
(60) Provisional application No. 60/704,839, filed on Aug. 2, 2005.

(51) Int. Cl. G06F 19/00

(52) U.S. Cl. 700/91

(57) ABSTRACT

An electronic wearable scorekeeping device for use with a racquet/court-related sport. The device includes a body capable of being attached to a sport participant, such as by a wristband, strap or, suspending lanyard worn by the user. The body includes a display face and a maximum of five individually depressible buttons, these related to at least one of a selected game type, player score, play/display mode, advantage/UFE, and time mode.

### CROSS REFERENCE TO RELATED APPLICATIONS

The present application claims the priority of U.S. Provisional Application No. 60/704,839 filed Aug. 2, 2005 for a “Wearable Electronic Scorekeeping Device”.

### BACKGROUND OF THE INVENTION

1. Field of the Invention

The present invention is a wrist-wearable scorekeeping device, such as worn by a participant in racquet court games such as tennis, racquetball, and table tennis, and which includes a total of five settable buttons for navigating through mode/menus, displays and score entry functions.

2. Description of the Prior Art

The prior art is well documented with examples of tennis and other portable type scorekeeping devices for assisting a player in keeping a correct score during game play. A first example from the prior art is set forth in U.S. Pat. No. 6,634,548, to Bowman, and which teaches a flexible strap removably attached to a casing, the casing in turn incorporating a circuit chip and a battery. The circuit chip is activated by one or more of four activation switches, these causing information (activities) to be displayed in one or more of four separate displays. Additionally, two additional activation switches are used to either turn the unit on/off and/or to reset one or more of the displays.

Another example of a personal tennis score keeper is disclosed in U.S. Pat. No. 5,489,122, to Pittner, and which teaches a strip of sheet material having an upper surface and a lower surface, the upper surface bearing squares arranged in a linear array and forming three columns. A first column bears indicia indicating the number of games won by a player, another indicates the number of games won by an opposing player, and the remaining bearing indicia for indicating a score of each player during a game. A plurality of score markers are slidably secured to the strip in a juxtaposed slidable relation with respect to a column for marking a score.

U.S. Pat. No. 3,777,699, issued to Pfleger, teaches a scoring device for tennis which accumulates and indicates the scoring for the game which is divided into and known as point score and game score. Scoring in tennis requires both an additive mode of operation for accumulating point score as well as game score, and a subtractive mode for point scoring under certain tie score conditions. The scoring device therefore comprises an input member and a totalize register for sequentially adding the point score until sufficient points have been accumulated to win the game. In advancing the point score register into the game winning indication the game totalizing register automatically advances to the next indication. The point score register is capable of the additive and the subtractive movements by selective movement of the input member. U.S. Pat. No. 4,331,098, issued to Rubano, teaches a tennis score keeper incorporating a small sized device for keeping score of a tennis match and which can be conveniently carried around on either a player's wrist or mounted on a racket. The device includes a frame on which is imprinted a row of point scores and a row of game scores along which arrows for each player are slidable.

Finally, U.S. Pat. No. 6,210,296, issued to Gabriel, teaches a portable tennis scorekeeper device with a body attachable to an article of apparel or insertable within a pocket thereof worn by a tennis player and including a scoreboard applied to a side of the portable body. The scoreboard includes a middle region and a pair of opposite side regions. The middle region includes a first portion having a plurality of numbers and letters associated with points scored in a game of a tennis match. A pair of tracks extend along opposite sides of the first portion, second and third portions each being disposed on a side of one of the tracks opposite from the first portion and having a plurality of numbers associated with points scored in a tiebreaker of the tennis match. A pair of markers are each mounted to and for undergoing movement along one of the tracks and are alignable with the numbers and letters of the first, second and third portions.

The side regions of the scorecard are each disposed on a side of one of the scorecard and third portions opposite from the tracks. Each side region includes a grid formed by a side axis, an end axis extending generally orthogonally to the side axis, a plurality of boxes arranged in rows and columns and aligned with one another adjacent to the side and end axes, a plurality of numbers associated with the games won in one or more sets of the tennis match being disposed numerically along the side axis and a plurality of numbers associated with sets of the match disposed numerically along the end axis. A plurality of markers are each mounted to and movable along the grid in generally orthogonal directions and positionable on one of the boxes of the grid and alignable with the numbers along each of the side and end axes of the grid.

### SUMMARY OF THE PRESENT INVENTION

The present invention discloses an electronic wearable scorekeeping device which is an improvement over prior art designs in that it provides a five button arrangement for game play and display functions. The device is further adaptable to a number of different racquet type sports and, in one preferred tennis variant, includes features such as scorekeeping, identifying game and set tally, as well as unforced errors.

A timekeeping mode is also employed and provides the ability to convert the wearable device between scorekeeping and watch functions. Additional features enable the present device to convert to scorekeeping in other related racquet sports, including badminton, racquetball, table tennis and the like.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of an electronic scorekeeping device according to the present invention for use with tennis and in particular showing the arrangement of the five pushbutton arrangement for switching between play, time, display modes;

FIG. 2 is a succeeding illustration of the electronic scorekeeping device and showing the display mode indicated;

FIG. 3 is a tabular illustration of a series of variable names and associated purpose/functions for the scorekeeping device according to the present invention;

FIG. 4 is a first flow schematic illustration of an initial play mode associated with the scorekeeping device of FIG. 1;

FIG. 5 is a succeeding tally score flow illustration associated with the present invention;

FIG. 6 is a flow schematic of a next game protocol;

FIG. 7 illustrates a flow schematic of a next set game play protocol;

FIG. 8 is a flow schematic of a normal score tally according to the present invention;

FIG. 9 is a flow schematic of a protocol associated with a tiebreaker scoring situation;

FIG. 10 is a flow schematic of a display score mode according to the present invention;

FIG. 11 is a clear score schematic according to the present invention;

FIG. 12 is a further succeeding display mode schematic; and

FIG. 13 is a final schematic illustration of the electronic scorekeeping device according to the present invention and which provides a selectable mode for different racquet sports including racquetball, badminton, etc.

### DETAILED DESCRIPTION OF THE PREFERRED EMBODIMENTS

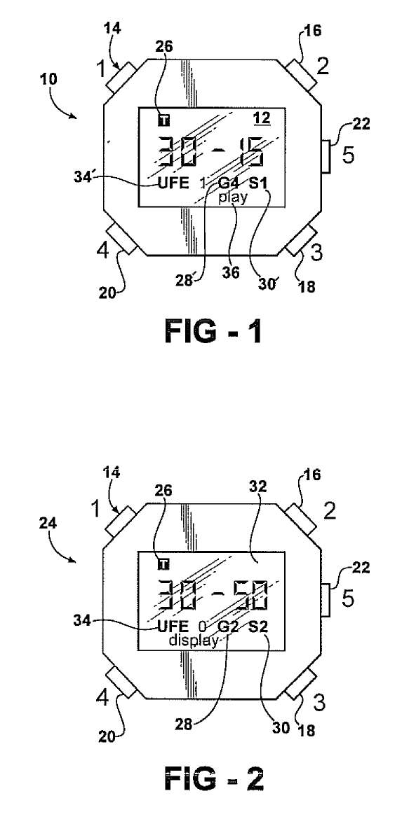

Referring now to FIG. 1, a wrist-wearable electronic scorekeeping device is illustrated at 10 according to a preferred embodiment of the present invention. As indicated previously, the scorekeeping device is typically worn by a participant of a court-related sport, and the device 10 represents a first embodiment directed to the game of tennis, it being understood that the wearable electronic scorekeeping device is equally applicable to other racquet sports such as racquetball, badminton, table tennis and the like.

In a preferred variant, the device 10 is worn upon a user's wrist (not shown). A strap or optional belt clip (also not shown) may also be provided for the wearability of the device, such as upon some secure location of the user, and such as again the belt or wrist.

Referring again to FIG. 1, the tennis scorekeeping device 10 includes a durable body exhibiting an LCD display face 12 and upon which are noted a series of indicia indications (such as in LCD format display) for indicating game play features associated with the present design. It is also understood that other means of illuminating display, such as including LED, phosphorescent or the like may also incorporated into the design.

A series of pushbuttons are illustrated (in one non-limiting variant as illustrated) at various locations around a side periphery of the body and include first player score toggle (or A button) 14 (exhibited along one side of the device), and corresponding to second player toggle (or B button) 16 exhibited along an opposite side. Each of these toggle buttons are considered “universal” buttons and will allow the wearer to scroll through scores in one direction only to simplify. Each of these buttons further include a slip-resistant surface and enable the participant/player to toggle (up or through) to display a current score.

A third display mode pushbutton is illustrated at 18 (see along lower right-hand side of the body), along with a fourth button 20 (lower left-hand side) is provided for viewing previously scored games and/or sets and matches. In play mode, fourth button 20 is provided for inputting unforced errors and clearing individual scores. Finally, a time mode button, see at 22 along right-hand side is provided for providing associated timer functions to the present design, such contemplated to include alternating between watch (i.e. timekeeping) and scoring functions through the pressing of a single button.

As will be subsequently described, the two main modes for scorekeeping are play mode and display mode. In play mode, a player can indicate which team (or individual player) has earned a point, and such as by depressing either button 14 or 16 once. Additionally, the user can increase entry of unforced errors (see again button 20) and can further clear an individual score (hold down button 20 for one second) or can clear all scores (hold button 20 for three or more seconds). Pressing button 18 will take the player to the display mode.

In the display mode, see illustration 24 in FIG. 2, a user can navigate through current matches (whether or not completed), and to select fourth button to view individual games or sets. In this mode, first button 14 increments which game/set to display, whereas second button 16 decreases which game/set is being displayed. Third button 18 reverts to play mode (back to a previous game) and fifth button 22 to time mode, as previously described. In the illustration 24 of FIG. 2, the device is illustrated in display mode according to the game of tennis (see indication 26 for “T”), game 2 (at 28) set 2 (at 30) and with a score of 30-50 (at 32), thus indicating a win by the “B” team with no unforced errors (at 34 for designation “UFE”). In contrast, the play mode of FIG. 1 is referenced, see on display face 12 at 36, as indicated by tennis mode (again at 26), game 4 (at 28′), set 1 (at 30′), score (30-15), indicating a lead by team/player “A” and with one unforced error (at 34′).

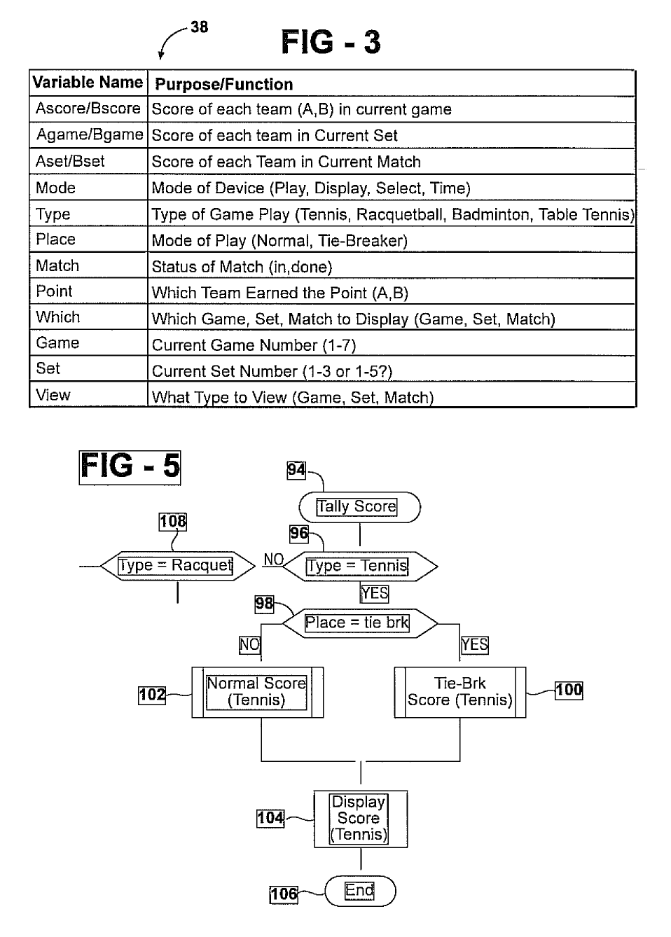

Referring now to FIG. 3, a tabular illustration is shown at 38 of a series of variable names and associated purpose/functions for the scorekeeping device according to the present invention. The purpose of FIG. 3 is to illustrate, in tabular form, a sequential listing of variables utilized to maintain scores and flags of functions as will be described in more detail with reference to the following flowchart illustrations.

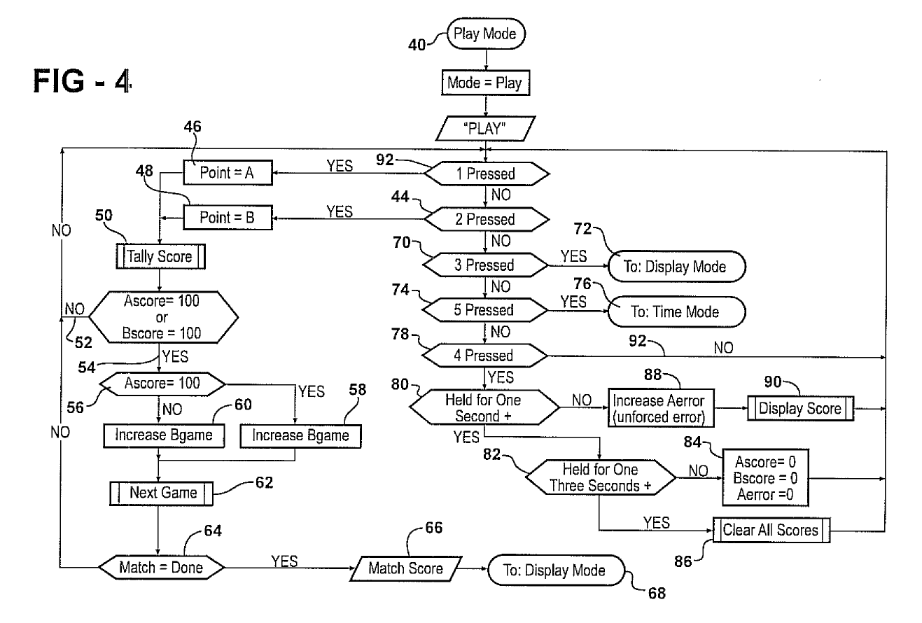

FIG. 4 illustrates a first flow schematic illustration of an initial play mode 40 associated with the scorekeeping device of FIG. 1. According to the flow sequence illustrated, a user presses button 1 (see again at 14 in FIGS. 1 and 2) and which commences by the user pressing either button (at 42) or button 2 (at 44) to determine the awarding of a point, to player A at 46 or to player B at 48.

Progressing to step 50, a tally score indication queries whether either party/team has successfully achieved a score of 100. If no, game play continues along step 52. If yes, and in the instance of an A score of 100 (as in step 56), a further instruct is made to increase a number of A games (at 58). If no, a further step 60 instructs to increase B game. At step 62, a next game is selected and succeeding step 64 queries if the match is completed. If so, match score 66 is indicated at 66 and the protocol returns to display mode at 68.

If the query to pressing button 2 (at 16) is no (referencing back to step 44) succeeding step 70 queries whether to depress button 3 (see again also 18 in FIG. 1). If yes, display mode is illustrated at 72. If no, a query whether to depress button 5 (at 22) is given at 74. If yes, the display proceeds to time mode 76 and, if no, to querying whether to depress button 4 (at 20) at step 78.

If the answer to query 78 is yes, a further query asks whether to depress button 4 (20) for one section (at 80 and thereby to clear a given player/team score). If yes, a further query asks whether to hold button 4 for three plus seconds (at step 82). If no (at 84) all scores (A, B and UFE) are at 0 (at step 84) and, if yes, all scores are cleared at step 86. If the answer to query 80 is no, step 88 instructs an increase of A error (again unforced error or UFE as referenced at 34 in FIG. 1) to eventual score display 90. Finally, and if the answer to query 78 is no (at 92), the protocol returns to initial play mode 40.

Referring now to FIG. 5 is a succeeding tally score flow illustration associated with the present invention, and in particular its ability to adapt to multiple game type variants, is shown at 94 and includes a first query, at 96, as to whether the game selection is tennis. If yes, at 98, a tiebreaker query is made and, if yes, a tiebreaker score is indicated at 100. If no, a normal tennis score is indicated at 102. Irrespective of selection 100 or 102, a display tennis score is referenced at 104 and the protocol ends at 106. If the query to 96 is no, a further query is posited at 108 as to the selection of another type of game, e.g. racquetball, with a remaining tally protocol being repeated as to steps 98-106.

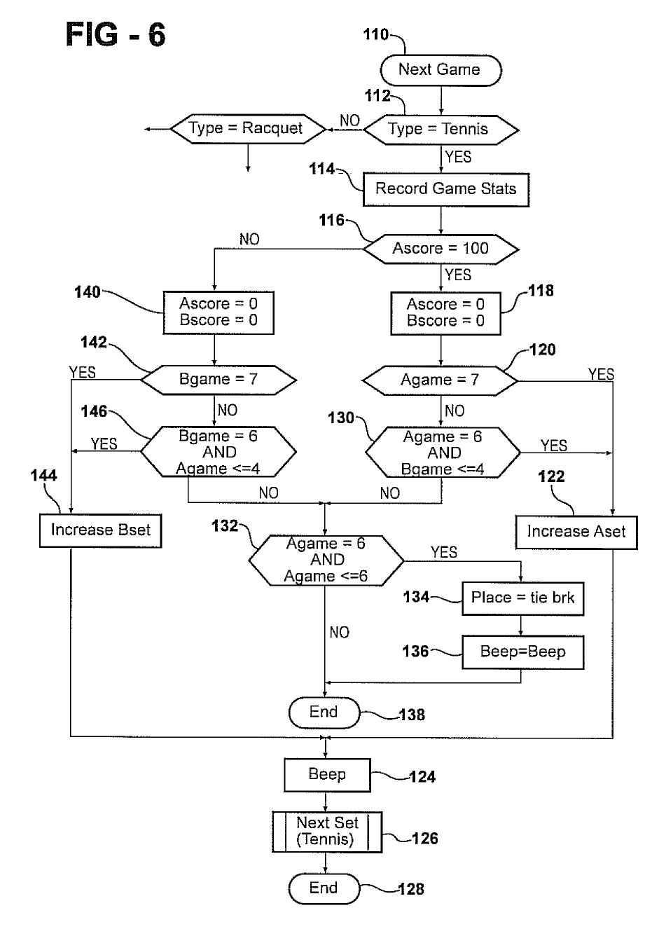

As is now shown in FIG. 6, is a flow schematic of a next game protocol indicated at 110 queries, at step 112, whether tennis is the selected game and, if yes, at step 114 instructs to record game statistics. At step 116, A player score is queried (e.g. as shown as 100) and, if yes, at step 118 the scores are zeroed out. At succeeding step 120, a number of A games (e.g. 7) is queried and, if yes, an increase of A sets is indicated at 122., succeeding which is the device issuing an audible sound (e.g. beep and which is understood to be incorporated into its hardware design) succeeding which a next set indication is shown at 126 and end step 128.

If the answer to query 120 is no, query 130 posits whether a given A and B game situation (e.g. Agame=6 AND Bgame<=4) exists. If yes, the protocol proceeds to step 122 previously described and, if no, a further query is posited whether both A and B games equal a given number (at 132 and shown as 6 games apiece). If yes, a tiebreaker indication is shown at 134 and, following a beep-beep audible alarm (see further at 136), the protocol proceeds to end step 138.

If the query to 116 is no, step 140 instructs both A and B scores to zero out, following which, at step 142, a query is made as to whether B team/player is referenced to have played a certain number of games (e.g. such as 7 and corresponding to Agame=7 query in step 120). If yes, a number of team B sets (Bset) is increased at 144. If no, query 146 reciprocates that shown at 130 and queries whether Bgame=6 AND Agame<=4). If yes, Bset is increased again at 144 and, if no, the protocol proceeds to step 132 previously described.

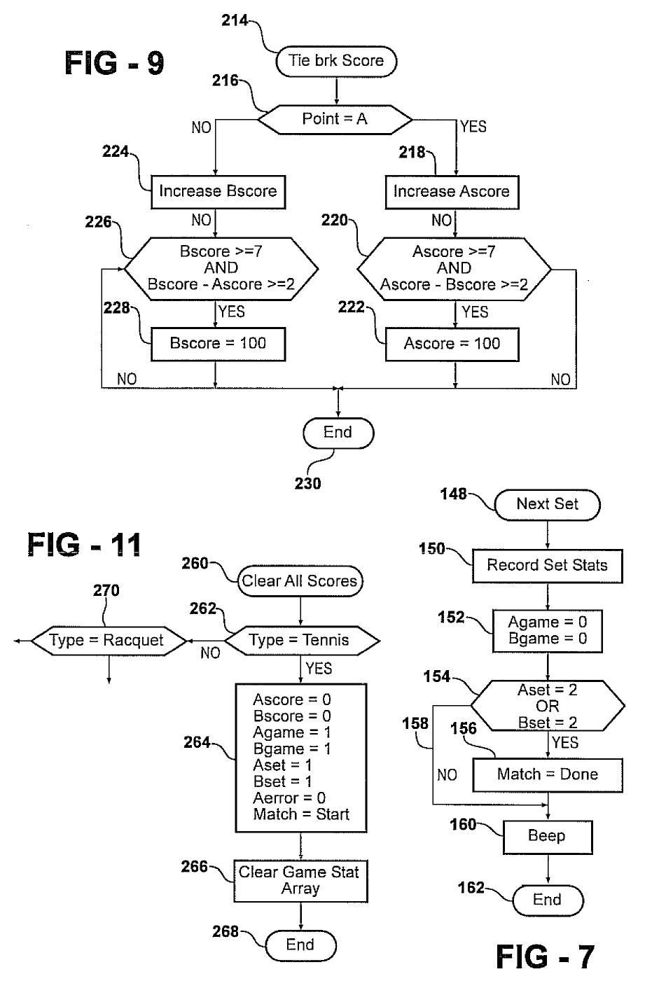

FIG. 7 illustrates a flow schematic of a next set game play protocol, at 148, and proceeds to a record set stats instruct at 150. Succeeding steps include an instruct to zero out both A and B games to zero (at 152) and to subsequently query, at step 154, if both an Aset or a Bset equals a specified number (e.g. 2). If yes, match completed indication is given at 156 and, if no (at 158), query 154 proceeds directly to beep indication 160 and end protocol step 162.

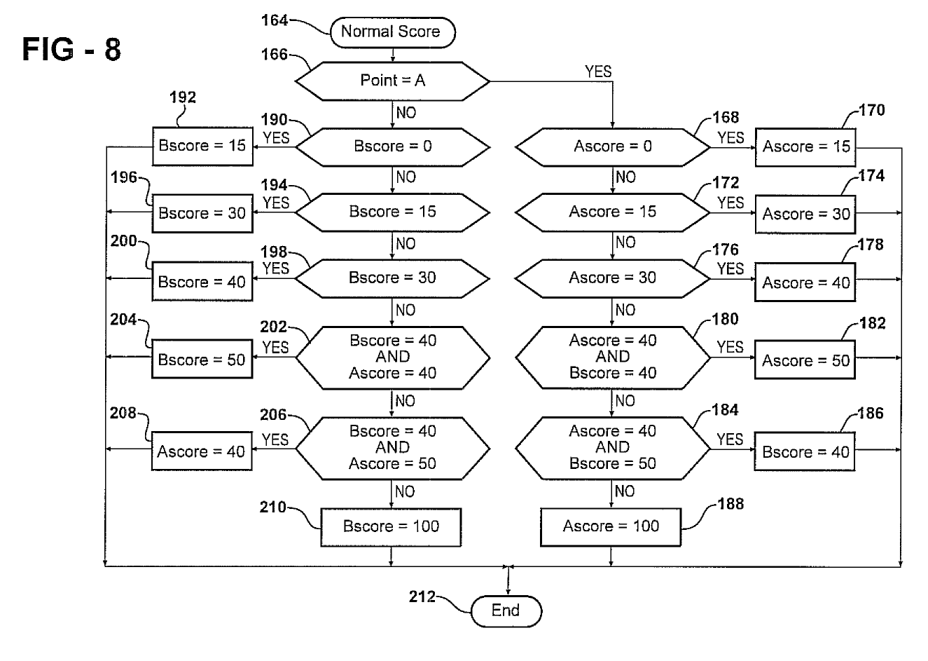

FIG. 8 is a flow schematic of a normal score 164 tally according to the present invention, such as again for tennis play, and queries at 166 if a point is to be awarded to player A. If yes, at 168, an Ascore=0 is queried. If yes, an Ascore may be increased, such as to equal 15 (at 170). If no to 168, a further query asks if Ascore is already at 15 (at 172). If yes, Ascore is queried at 30 (at 174) and, if no, Ascore is queried whether at 30 (at 176). If yes, at 178, Ascore is advanced to 40 and, if no, a combined A and B score of 40 apiece is queried, at 180, whether as being 40 apiece. If yes, Ascore is advanced to 50 (at 182) and, if no, queried further at 184 whether an Ascore=40 and a Bscore=50. If yes to 184, Bscore is advanced to 40 and, if no, Ascore to 100 (at 188).

The protocol of steps 168-188 is repeated in reciprocal as shown in FIG. 8 for query 190 as to whether Bscore=0 (this reciprocating previously described query 168). Succeeding query steps 192-210 are referenced in downwardly progressing fashion along the left side column of the flowchart of FIG. 8 and correspond with each of previously described steps 170-188. The protocol of FIG. 8 concludes with end step 212, progressing from either described step 188 or 210.

FIG. 9 is a flow schematic of a protocol associated with a tiebreaker scoring situation 214 and queries, at 216, whether to increase Ascore (at 218). If no, at step 220, a query is made whether to advance an Ascore, such as to >=7 AND Ascore-Bscore>=2). If yes, at 222, Ascore is advanced to 100.

Steps 224, 226 and 228 correspond reciprocally to steps 218, 220 and 222, as to increasing Bscore, and if yes to either query 220 or 226, either the A or B score is advanced to 100 and end step 230 referenced. If no to either 220 or 226, the protocol proceeds directly to end step 230.

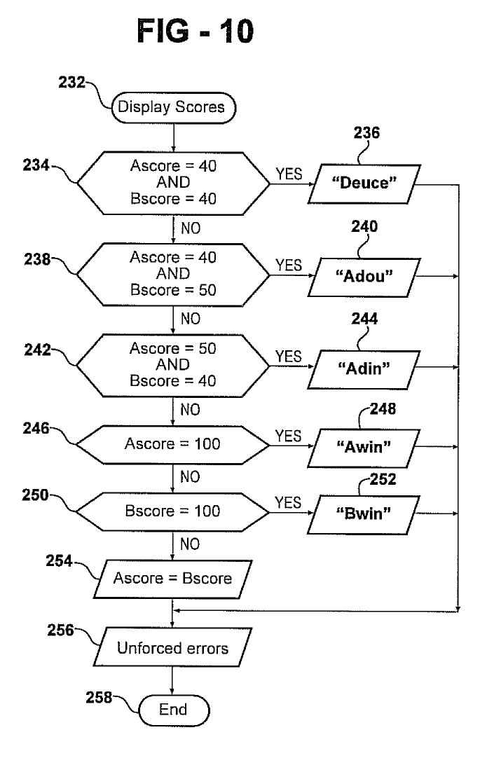

FIG. 10 is a display score flow schematic 232 and queries, at 234, whether A and B score both equal 40. If yes, at step 236, “deuce” indication is made and, if no, a query is made at 238 whether Ascore=40 and Bscore=50. If yes “Adou” indication is made at 240 and, if no, further query 242 asks is Ascore=50 and Bscore=40. If yes, at 244 “Adin” is indicated and, if no, Ascore=100 is further queried at 246. If yes, at 248, “Awin” (A team wins) is indicated at 248 and, if no, Bscore=100 is queried at 250. If yes, Bwin (B team wins) is indicated at 252.

If no to query 250 (or if yes to any preceding indications 236, 240, 244, 248 and 252), further Ascore:Bscore (e.g. the present team scores where either team has some point total under 100, or any other preset total point amount constituting a win) is referenced at 254. Following that, an unforced errors (UFE) indication is given at 256 and proceeds to end protocol step 258.

FIG. 11 is a clear score schematic according to the present invention and references, at 260, an all scores cleared indication. At 262, a further query is made if the protocol application is for tennis and, if yes, a succeeding series of indications are provided, at 264, as to A/B score, game, set, error and match start particulars. At 266, a clear game stat array command is given and, at 268 the protocol ends. If the query to 262 is no, a further query (270) requests if the application is for another type of game, e.g. racquetball, and then proceeds to repeat the protocol steps associated with that game and as previously described at 262-268.

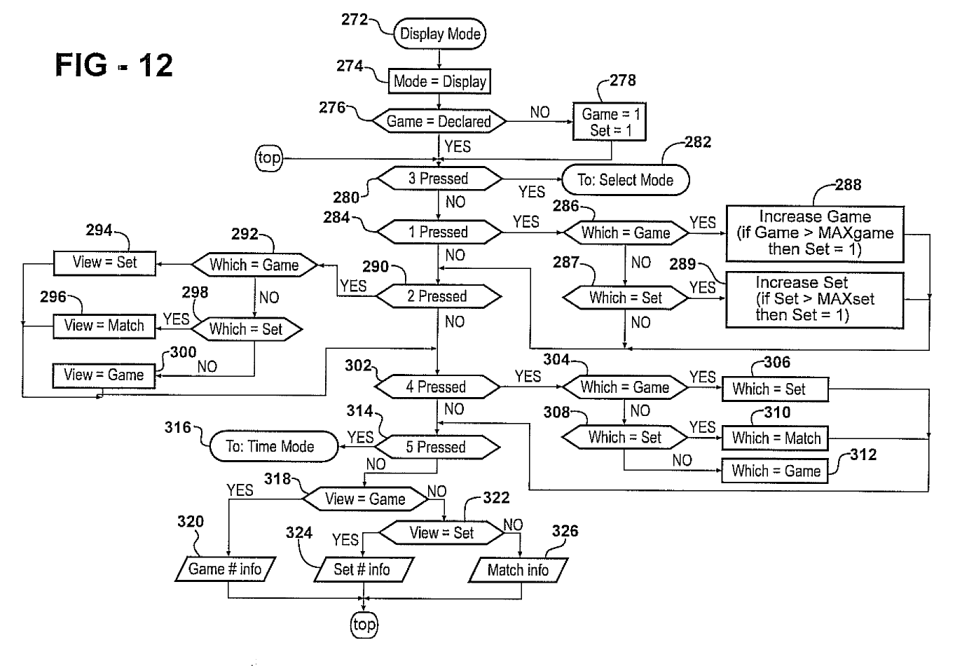

FIG. 12 is a further succeeding display mode schematic at 272 (see also again FIG. 2) and progresses to mode=display commend 274 and, subsequently, to game=declared query 276. If no, game=1 set=1 indication is made at 278 and, if yes, query 280 posits whether button 3 (at 18) is depressed. If yes, select mode is referenced at 282 and, if no, query 284 asks as to whether button 1 is depressed. If yes, which=game indication is made at 286 and proceeds, if yes, to increasing a game or maximum game number at 288. If the query to 286 is no, query 287 asks the set number being played (Which=set) and if yes, command 289 increments a set maximum whereas, and if no, protocol command advances to query 290 (also achieved by answering no to query 284) which posits whether button 2 is to be depressed. If yes, which=game query is referenced at 292 and, if yes, view=set indication is provided at 294. If no to query 292, which=set query is posited at 298 and, if yes, view=match indication is made at 296 and, if no, view=game indication at 300.

Either of steps 296 and 300, as well as a negative answer to query 290, progress to a query at to pressing button 4, at 302. If yes, which=game query is made at 304 and, if yes again, which=set indication is made at 306. If no to 304, which=set query is posited at 308 and, if yes to that, which=match indication is made at 310 and, if no to 308, which=game indication at 312. If no to query 302, further query 314 asks if button 5 is to be depressed. If yes, “to: time mode” indication is provided at 316 and, if no, view=game query is asked at 318. If yes, “game# information” is provided at 320. If no to 318, view=set query is provided at 322. Finally, a yes answer to query 322 progresses to a “set# info” indication at 324 or, if no to 322, to a “match info” indication 326, from any of 320, 324, or 326 commands, the display mode 272 repeats.

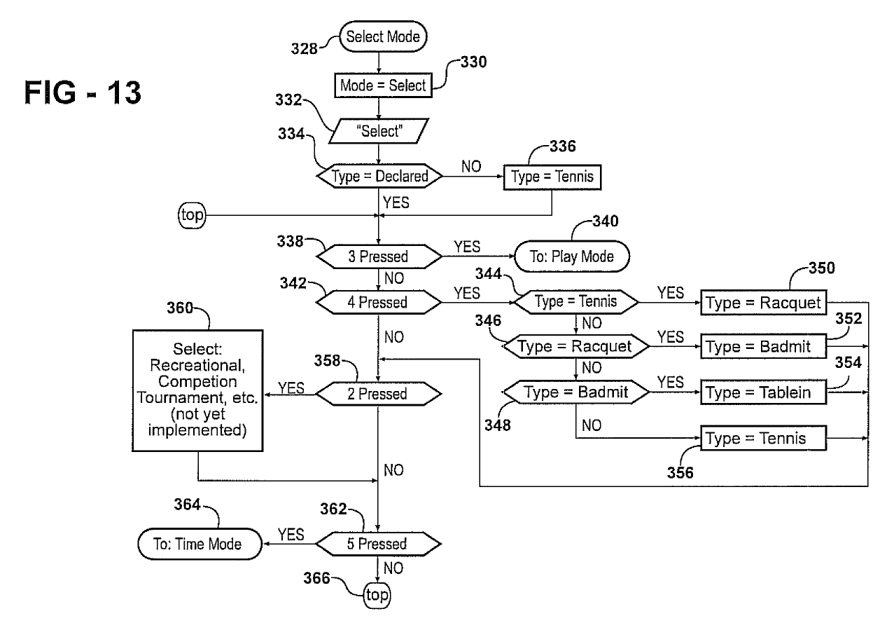

FIG. 13 is a final schematic illustration of the electronic scorekeeping device, at 328, according to the present invention and which provides a selectable mode for different racquet sports including racquetball, badminton, and the like. In particular, mode=select indication is made at 330 and progresses to select command 332. A further query, at 334, asks whether type=declared and, if no, can reference type=tennis at 336 or, alternatively and if yes to 334, query 338 asks if button 3 is to be pressed. If yes, the protocol proceeds to play mode 340 and, if no, query 342 asks (posits) if button 4 is to be pressed. If yes again, a type of game play selection is made and may include selected tennis (344), racquetball 346 or badminton 348.

If yes to any of 344, 346, or 348, a further selected one of “type=racquet” (350), “type=badmit” (352) or “type=tennis” (354) commands is given. If no to all, “type=tennis” (356) is selected as the default and proceeds to query 358 as to whether button 2 is to be pressed. If yes to that query, display 360 indicates a potential selection of a given level of game play, e.g., recreational, competition, tournament, etc., and, if no to 358, further query 362 asks if button 5 is to be pressed. If yes to 362, “time mode” indication is made at 364 and, if no, at 366 the protocol returns to display mode 328.

The electronic scorekeeping device, according to any preferred variant, includes a power supply in the form of a watch battery and which is similar to that used with other conventional types of electronics, cameras, watches, etc. In a preferred application, the device 10 is universally applicable to all court-related sports and, potentially, other recreational sports. Additional features include built-in illumination, in the event of operating the watch in semi-darkness or other limited light conditions (see again lighted display face 12 and 32 in FIGS. 1 and 2, respectively), a scratch-resistant display surface (e.g. sapphire crystal), audible signaling (e.g. a beep or chime sound to indicate match/set), as well as colorful designs and stylish arrangements to enhance the attractiveness of the device.

It is also envisioned that a single electronic wearable device can be programmed to operate according to all of the game play variants. Such a device can also be adapted to include other participant related games, beyond those described, and by which it is desirable to incorporate an electronic type device with processor capabilities for inputting scoring and other relevant parameters associated with game play (volleyball, handball, wallyball, etc.).

The previously described scoring protocol illustrations are relevant to the various embodiments of the present invention and which establish the manner in which the electronic device is manipulated according to a given game play variant. The protocol information is submitted as being exemplary only of one manner in which the electronic scorekeeping device is utilized and is not interpreted as limiting as to the manner in which the device may be configured or operated. It is also envisioned that the wearable scorekeeping device can be adapted to operate with other, non-racquet related sports including such as volleyball, or any other player/team participant sport related game or event.

Having described my invention, other and additional preferred embodiments will become apparent to those skilled in the art to which it pertains, and without deviating from the scope of the appended claims.

I claim:

1. An electronic wearable scorekeeping device for use with a sport, comprising:
a device body capable of being attached to a sport participant; and
the body including a display face and a maximum of five individually depressible buttons for displaying at least one of a selected game type, player score, play/display mode, advantage/UFE, and time mode.

2. The electronic wearable scorekeeping device as described in claim 1, said display face including an LCD display.

3. The electronic wearable scorekeeping device as described in claim 2, said LCD display including a backlighting display for operation in semi-darkness.

4. The electronic wearable scorekeeping device as described in claim 1, further comprising a first player scoring button and a second player scoring button.

5. The electronic wearable scorekeeping device as described in claim 4, further comprising a third display mode button.

6. The electronic wearable scorekeeping device as described in claim 5, further comprising a fourth clear score/reset button.

7. The electronic wearable scorekeeping device as described in claim 6, further comprising a fifth time function button.

8. The electronic wearable scorekeeping device as described in claim 1, each of said inwardly depressible buttons further comprising a slip-resistant surface.

9. The electronic wearable scorekeeping device as described in claim 1, said display face indicating a game selection including at least one of tennis, table tennis, racquetball, and badminton.

10. An electronic wearable scorekeeping device for use with a racquet type sport, comprising:
a device body capable of being attached to a sport participant;
the body including a display face and a plurality of individually depressible buttons for displaying at least one of a selected game type, player score, play/display mode, advantage/UFE, and time mode; and
said buttons further comprising at least:
a first player scoring button and a second player scoring button;
a third display mode button; and
a fourth clear score/reset button.

11. The electronic wearable scorekeeping device as described in claim 10, further comprising a fifth time function button.

12. The electronic wearable scorekeeping device as described in claim 10, each of said inwardly depressible buttons further comprising a slip-resistant surface.

13. The electronic wearable scorekeeping device as described in claim 10, said display face indicating a game selection including at least one of tennis, table tennis, racquetball, and badminton.

14. The electronic wearable scorekeeping device as described in claim 10, said display face including an LCD display.

15. The electronic wearable scorekeeping device as described in claim 14, said LCD display including a backlighting display for operation in semi-darkness.

16. An electronic wearable scorekeeping device for use with a racquet-type sport, comprising:
a device body capable of being attached to a sport participant and including a display face including a backlighting display for operation in semi-darkness; and
said display face presenting a plurality of individually depressible buttons for displaying at least one of a selected game type, player score, play/display mode, advantage/UFE, and time mode.

17. The electronic wearable scorekeeping device as described in claim 1, further comprising a first player scoring button and a second player scoring button.

18. The electronic wearable scorekeeping device as described in claim 17, further comprising a third display mode button.

19. The electronic wearable scorekeeping device as described in claim 18, further comprising a fourth clear score/reset button.

20. The electronic wearable scorekeeping device as described in claim 19, further comprising a fifth time function button.
